(19) United States
(12) Patent Application Publication
(10) Pub. No.: US 2022/0231363 A1
(43) Pub. Date: Jul. 21, 2022

(54) A PRISMATIC BATTERY MODULE USING ASEISMATIC DAMPING GLUE

(71) Applicant: TESA SE, Norderstedt (DE)

(72) Inventors: Haofeng YANG, Suzhou (CN); Yuanlei DING, Suzhou (CN)

(73) Assignee: TESA SE, Norderstedt (DE)

(21) Appl. No.: 17/609,563

(22) PCT Filed: May 8, 2020
(86) PCT No.: PCT/EP2020/062948

§ 371 Date: Nov. 8, 2021

(30) Foreign Application Priority Data
May 8, 2019 (CN) 201920652462.X

(51) Int. Cl. H01M 50/198; H01M 50/103; H01M 50/242

(52) U.S. Cl. CPC H01M 50/198; H01M 50/242; H01M 50/103

(57) ABSTRACT

wherein the prismatic battery module include a plurality of cells, structural parts, and adhesive tapes. The plurality of cells is arranged side by side, wherein, on each cell of the cells, the adhesive tape is continuously bound onto one main surface and two adjacent side surfaces of the cell and also bound onto another one main surface of a cell, which is located at the end of the plurality of cells arranged side by side. As a result, the adhesive tape is bound onto all around the plurality of cells arranged side by side and the plurality of cells is bound with each other by the adhesive tape respectively bound onto one main surface of each of the cells such that the prismatic battery modules achieve at least one of easy assembly, good heat dissipation, and good vibration resistance.

### TECHNICAL FIELD

The invention relates to the field of batteries, in particular to a prismatic battery module using aseismatic damping glue.

### BACKGROUND ART

With the strong support of the country, pure electric and hybrid vehicles have achieved rapid development. The battery is the key component for energy storage, and its development level directly determines the promotion speed of electric vehicles. According to the package and appearance of the cell, the types of cells used in electric vehicles are mainly divided into square aluminum shell (steel shell) cells, cylindrical cells and soft-pack cells. The square cell has become the most used cell type in the electric vehicle field due to its high unit energy and easy to group etc.

In order to ensure that electric vehicles can better meet people's use under various complicated working conditions, power batteries need to be designed carefully. First of all, in order to ensure that the single cell does not affect the adjacent cells when it is overheated, it is necessary to make insulation design between the cells. Secondly, a buffer space needs to be reserved between the cells to absorb the shrinkage and expansion of the cells during use, thereby avoiding the risk of mutual extrusion between the cells and breakage of the structural parts. Finally, during the use of electric vehicles, various complex road conditions will be encountered. The power battery needs to be designed to resist vibration to avoid damage caused by the vibration to the cells.

As to the above problems, we designed a new type of tape, and the prismatic battery module was designed and assembled based on this tape.

### Content of the Invention

The purpose of the invention is to provide a prismatic battery module with excellent comprehensive performance assembled by using an aseismatic damping glue.

According to a first aspect of the present invention, a prismatic battery module is provided, including a plurality of cells, structural parts and adhesive tapes, wherein

the plurality of cells are arranged side by side;

on each of the cells, the adhesive tape is continuously bound onto one main surface and two adjacent side surfaces of the cell; and, the adhesive tape is bound to another one main surface of a cell which is located at the end of the plurality of cells arranged side by side, such that the adhesive tape is bound onto all around the plurality of cells arranged side by side;

the plurality of cells are bound with each other by the adhesive tape respectively bound onto one main surface of each of the cells;

the structural part is configured to fix the plurality of cells, and the structural part includes two side plates respectively disposed on two side surfaces of the plurality of cells arranged side by side and two end plates respectively disposed on two main surfaces of the plurality of cells arranged side by side, the two side plates and the two end plates are bound to the plurality of cells by adhesive tapes bound to all around the plurality of cells arranged side by side.

In another preferred embodiment, the adhesive tape comprises an adhesive layer 1, an insulating layer and an adhesive layer 2;

the adhesive layer 1 includes a first adhesive layer bound to the upper end of the first main side of the insulating layer and a second adhesive layer bound to the lower end of the first main side of the insulating layer;

the adhesive layer 2 is bound to the second main side of the insulating layer; and the adhesive layer 1 is an aseismatic damping glue selected from the group consisting of:

a1) acrylic foam glue;

a2) acrylic foam glue coated with first glue on one side;

a3) acrylic foam glue coated with first glue on both sides.

In another preferred embodiment, the prismatic battery module has one or more features selected from the group consisting of:

1) the insulating layer is formed of a material selected from the group consisting of: PET, PE, PP, PC, PI, PBT, PES, or a combination thereof;

2) the adhesive layer 2 is selected from the group consisting of acrylic tape (i.e. acrylic glue layer without acrylic foamed foam substrate), rubber tape, silicone tape and aseismatic damping glue, wherein the aseismatic damping glue is selected from the group consisting of:

a1) acrylic foam glue;

a2) acrylic foam glue coated with first glue on one side;

a3) acrylic foam glue coated with first glue on both sides. In another preferred embodiment, the prismatic battery module has one or more features selected from the group consisting of:

1) the width of the first adhesive layer and the width of the second adhesive layer are the same or different, and are independently selected from the group consisting of: 5-20 mm, 8-18 mm, 10-15 mm;

2) the first adhesive layer and the second adhesive layer have the same thickness which is selected from the group consisting of 0.5-5 mm, 0.8-3 mm, 1-2 mm;

3) the insulating layer has a thickness selected from the group consisting of: 10-300 μm, 25-250 μm, 40-150 μm, 50-130 μm;

4) the insulating layer has a width selected from the group consisting of: 50-200 mm, 70-150 mm, 80-140 mm;

5) the adhesive layer 2 has a thickness selected from the group consisting of 10-100 μm, 25-80 μm, 30-60 μm, 0.1-2.5mm, 0.3-2.2 mm, 0.5-2 mm, 0.8-1.8 mm, 1-1.8 mm;

6) the width of the adhesive layer 2 is the same as the width of the insulating layer.

In another preferred embodiment, the adhesive layer 2 comprises a third adhesive layer bound to an upper end of the second main side of the insulating layer and a fourth adhesive layer bound to lower end of the second main side of the insulating layer.

In another preferred embodiment, the prismatic battery module has one or more features selected from the group consisting of:

1) the third adhesive layer and the fourth adhesive layer may have the same or different widths which are independently selected from the group consisting of: 5-20 mm, 8-18 mm, 10-15 mm;

2) the third adhesive layer and the fourth adhesive layer have the same thickness which is selected from the group consisting of 0.5-5 mm, 0.8-3 mm, 1-2 mm.

In another preferred embodiment, the ratio of the width of the third adhesive layer to the width of the first adhesive layer is 1-1.5 (preferably 1.05 to 1.4, more preferably 1.1 to 1.35), and the first adhesive layer is symmetrically disposed with the third adhesive layer; and/or

the ratio of the width of the fourth adhesive layer to the width of the second adhesive layer is 1-1.5 (preferably 1.05 to 1.4, more preferably 1.1 to 1.35), and the second adhesive layer is symmetrically disposed with the fourth adhesive layer.

In another preferred embodiment, the adhesive layer 2 is an aseismatic damping glue selected from the group consisting of:

a1) acrylic foam glue;

a2) acrylic foam glue coated with first glue on one side;

a3) acrylic foam glue coated with first glue on both sides.

In another preferred embodiment, a single cell has a thickness of D1, and the adhesive layer 1 has a thickness of D2, and D1/D2 is 2.5 to 30, preferably 3 to 25, more preferably 5 to 20.

In another preferred embodiment, the margin of the insulating layer of the adhesive tape in the width direction is coated onto a partial region of the top surface and the bottom surface of each of the cells.

In another preferred embodiment, the composition and the structure of the first adhesive layer and those of the second adhesive layer are the same.

In another preferred embodiment, the composition and the structure of the third adhesive layer and those of the fourth adhesive layer are the same.

In another preferred embodiment, the acrylic foam glue has one or more characteristics selected from the group consisting of:

1) the acrylic foam glue is a single layer structure, and the surface thereof is not coated with glue;

2) the acrylic foam glue is a substance formed by mixing and polymerizing a flexible acrylic monomer and a rigid acrylic monomer, filler, a reaction auxiliary agent and an additive etc;

3) the acrylic foam glue is mainly characterized by excellent shape retention and adhesion, and a thicker product can be obtained according to requirements;

4) the acrylic foam glue is prepared as follows: firstly, mixing and stirring the raw materials such as acrylic monomers, fillers, reaction auxiliaries, additives, modifiers, etc. according to the formulation proportion at a temperature and a time required by the process; then, the obtained mixture is spray-coated onto a release paper according to the required thickness; then, further reaction is carried out by high temperature or UV light irradiation, and finally the desired product is obtained.

For acrylic foam glue, by way of example and not limitation, reference may be made to the disclosure of CN 106674417 A wherein the preparation of the foam substrate layer was disclosed.

In another preferred embodiment, the first glue is acrylic glue.

In another preferred embodiment, in the “acrylic foam glue coated with a first glue on one side”, the acrylic foam glue has a thickness of 0.2-5 mm (preferably 0.5-4 mm, more preferably 1-3 mm); the first glue has a glue thickness of 10-100 μm (preferably 20-80 μm, more preferably 30-60 μm).

In another preferred embodiment, in the “acrylic foam glue coated with a first glue on both sides”, the acrylic foam glue has a thickness of 0.2-5 mm (preferably 0.5-4 mm, more preferably 1-3 mm); the first glue has a single-sided glue thickness of 10-100 μm (preferably 20-80 μm, more preferably 30-60 μm).

In the present invention, the “acrylic foam glue” itself has a certain viscoelasticity, and its peeling force to the steel sheet is ≥5 N/cm, preferably ≥10 N/cm, more preferably ≥20 N/ cm.

In another preferred embodiment, the aseismatic damping glue has one or more characteristics selected from the group consisting of:

1) the peeling force of the aseismatic damping glue to the steel plate is ≥5 N/cm, preferably ≥10 N/cm, more preferably ≥20 N/cm;

2) the aseismatic damping glue has a surface pressure value of ≥500 KPa, preferably ≥800 KPa, more preferably ≥1000 KPa, when the compression ratio is 50%;

3) when the compression speed is 50 mm/min and the compression ratio is 50%, the absolute value of the “compression force-resilience force” of the aseismatic damping glue ΔF1 is ≥700 KPa, preferably ≥800 KPa, more preferably ≥900 KPa;

4) when the compression speed is 600 mm/min and the compression ratio is 50%, the absolute value of the “compression force−resilience force” of the aseismatic damping glue ΔF2 is ≥1500 KPa, preferably ≥1600 KPa, more preferably ≥1700 KPa;

5) the ratio of ΔF2 to ΔF1 is ≥1.3, preferably ≥1.5, more preferably ≥1.8.

In the present invention, the term “aseismatic damping glue”, “anti-vibration elastic rubber” and “acrylic foam tape (ACX)” have the same meaning and can be used interchangeably.

In another preferred embodiment, a single cell has a thickness of D1, and the adhesive layer 2 has a thickness of D3, and D1/D3 is selected from the group consisting of 2.5-30, 3-25, 5-20, 100-550, 150-500, 200-450, 300-430.

In another preferred embodiment, the structural pars refer to components (which generally is metal) located at the side and both ends of the module, they further fix the cells by binding with the tape bound on the side and both ends of the cell and soldering (between the side plate and the end plate), and they further provide the connection points required for the fixation of the module in the battery box.

It should be understood that in the scope of the present invention, any of the technical features specifically described above and below (such as in the Examples) can be combined with each other, which will not redundantly be described one by one herein.

### DESCRIPTION OF FIGURES

FIG. 1 is a structural schematic view of tape as type 1 in Example 1 of the present invention, the left is a front view, and the right is a side view.

FIG. 2 is a structural schematic view of tape as type 2 in Example 2 of the present invention, the left is a front view, and the right is a side view.

FIG. 3 is a structural schematic view of tape as type 2 in Example 3 of the present invention, the left is a front view, and the right is a side view.

FIG. 4 is a structural schematic view of a cell bound with the adhesive tape obtained in Example 4 of the present invention.

FIG. 5 is a structural schematic view of a cell bound with the adhesive tape obtained in Example 5 of the present invention.

FIG. 6 is a structural schematic view of the prismatic battery module of the present invention.

FIG. 7 is an installation schematic view for the sample in the tape compression test.

FIG. 8 is a compression resilience curve for acrylic foam tape.

FIG. 9 is a compression resilience curve for PE foam tape and PU foam tape.

FIG. 10 is a compression resilience curve for ACX+PE tape and ACX+PU tape.

### DETAILED DESCRIPTION OF INVENTION

Through extensive and intensive long research, the inventors have obtained a prismatic battery module with excellent comprehensive performance by designing and adjusting the composition and structure of the tape and applying it to the assembly of the prismatic battery module. In particular, the prismatic battery module of the present invention does not require the use of a frame structure, and the assembly of the prismatic battery module can be realized simply and efficiently by only using the tape of the specific composition and structure of the present invention. In the prismatic battery module of the present invention, the strong binding property of the adhesive layer of the tape enables the adjacent cells and the entire battery to be effectively fixed, and the damping formed by the adhesiveness of the tape makes that the prismatic battery module is provided with excellent anti-vibration performance; the considerable space discontinuity existing between the adhesive layers of the adhesive tape and the compressibility of the adhesive layer itself make that the prismatic battery module can effectively absorb the expansion of the cell during use; the considerable space discontinuity existing between the adhesive layers of the adhesive tape and the presence of the central insulating layer of the tape can effectively achieve heat dissipation and insulation during use of the cell. On this basis, the inventors finished the present invention.

Tape

The tape of the present invention mainly comprises the following two types:

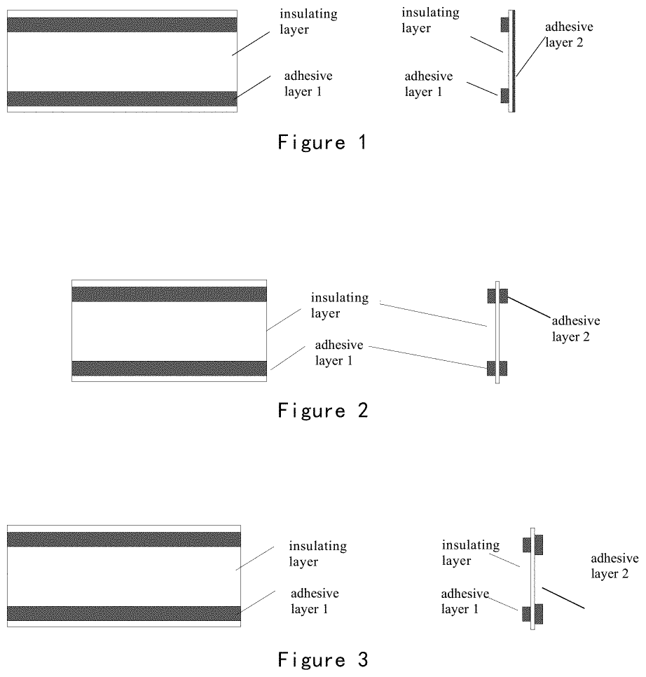

type 1: as shown in FIG. 1, the adhesive tape comprises: an adhesive layer 1, an insulating layer and an adhesive layer 2, wherein

the adhesive layer 1 is bound to the first side of the insulating layer, and the adhesive layer 1 is strip-shaped, and the adhesive layer 1 comprises a first adhesive layer bound to the upper end of the first side of the insulating layer and a second adhesive layer bound to the lower end of the first side of the insulating layer;

the adhesive layer 2 is bound to the second side of the insulating layer, and the area of the adhesive layer 2 is the same as the area of the insulating layer.

type 2: as shown in FIG. 2 or FIG. 3, the adhesive tape comprises: an adhesive layer 1, an insulating layer and an adhesive layer 2, wherein

the adhesive layer 1 is bound to the first side of the insulating layer, and the adhesive layer 1 is strip-shaped, and the adhesive layer 1 comprises a first adhesive layer bound to the upper end of the first side of the insulating layer and a second adhesive layer bound to the lower end of the first side of the insulating layer;

the adhesive layer 2 is bound to the second side of the insulating layer, and the adhesive layer 2 is strip-shaped, and the adhesive layer 2 comprises a third adhesive layer bound to an upper end of the second main side of the insulating layer and a fourth adhesive layer bound to lower end of the second main side of the insulating layer;

the first adhesive layer and the third adhesive layer are oppositely bound on both sides of the insulating layer, and the second adhesive layer and the fourth adhesive layer are oppositely bound on both sides of the insulating layer.

It should be understood that the number of the adhesive layer 1 is not particularly limited and may be 2, 3, 4, 5 and 6. In the examples of the present invention, taken 2 for example.

It should be understood that, in the tape of type 2, the number of the adhesive layer 2 is not particularly limited and may be 2, 3, 4 or 5. In the examples of the present invention, taken 2 for example.

Preferably, in the tape of type 2, the number of the adhesive layers 1 is the same as the number of the adhesive layers 2.

The insulating layer is made of an insulating material selected from the group consisting of PET (polyethylene terephthalate), PE (polyethylene), PP (polypropylene), PC (polycarbonate), PI (polyimide), PBT (polybutylene terephthalate), PES (polyether sulfone resin), or a combination thereof.

The thickness of the insulating layer is selected from the group consisting of 10-300 μm, 25-250 μm, 40 -150 μm, 50 -130 μm.

The width of the insulating layer is selected from the group consisting of 60-200 mm, 70-150 mm and 80-140 mm.

The width of the insulating layer is larger than the height of the cell.

In the adhesive tape of type 1, the material forming the adhesive layer 1 and the adhesive layer 2 may be the same or different, wherein the adhesive layer 1 is an acrylic foam tape (ACX), and the adhesive layer 2 is acrylic foam tape (ACX) or glue (such as acrylic glue, preferably with anti-lift properties).

In the tape of type 2, the material forming the adhesive layer 1 and the adhesive layer 2 are the same, and both are acrylic foam tape (ACX).

The width of the first adhesive layer and that of the second adhesive layer may be the same or different (preferably the same), and are independently selected from the group consisting of 7-20 mm, 8-18 mm, 10-15 mm.

The first adhesive layer and the second adhesive layer have the same thickness selected from the group consisting of 0.5-5 mm, 0.8-3 mm and 1-2 mm.

The first adhesive layer and the second adhesive layer are both arranged in a direction parallel to the tape extension.

The sum of the width of the first adhesive layer and the width of the second adhesive layer is 5-30%, preferably 10-25%, more preferably 15-25% of the height of the cell.

The farthest distance of the first adhesive layer and the second adhesive layer is selected from the group consisting of 40-180 mm, 50-130 mm and 60-120 mm.

In the tape of type 1, the thickness of the adhesive layer 2 is selected from the group consisting of 10-100 μm, 25-80 μm-30-60 μm, 0.1-2.5 mm, 0.3-2.2 mm, 0.5-2 mm, 0.8-1.8 mm, 1-1.8 mm;

the width of the adhesive layer 2 is the same as the width of the insulating layer.

The third adhesive layer and the fourth adhesive layer may have the same or different widths (preferably the same), which are independently selected from the group consisting of 7-20 mm, 8-18 mm and 10-15 mm.

The third adhesive layer and the fourth adhesive layer have the same thickness which is selected from the group consisting of 0.5-5 mm, 0.8-3 mm and 1-2 mm.

The third adhesive layer and the fourth adhesive layer are both arranged in a direction parallel to the tape extension.

The sum of the width of the third adhesive layer and the width of the fourth adhesive layer is 5-30%, preferably 10-25%, more preferably 15-25% of the height of the cell.

The farthest distance of the third adhesive layer and the fourth adhesive layer is selected from the group consisting of 40-180 mm, 50-130 mm and 60-120 mm.

In the tape of type 2, the first adhesive layer and the third adhesive layer have the same width and are symmetrically disposed;

the second adhesive layer and the fourth adhesive layer have the same width and are symmetrically disposed.

In the tape of type 2, the first adhesive layer and the third adhesive layer have different widths and are symmetrically disposed;

the second adhesive layer and the fourth adhesive layer have different widths and are symmetrically disposed.

It should be understood that the outer side of the adhesive layer contains a release layer prior to use.

It should be understood that in the adhesive tape of the present invention, the width refers to a dimension perpendicular to the extending direction of the tape and parallel to the plane of the tape, the thickness refers to a dimension perpendicular to the plane of the tape.

Typically, the tape of type 1 is as follows: the adhesive layer 1 is an acrylic foam tape (ACX) having a high cohesion, having a width of 10 mm, a thickness of 1.5 mm, and a number of two. Dimensions and quantities can be changed according to the needs and characteristics of the adhesive layer, and flame retardant acrylic foam tape (ACX) can be used according to requirements.

The material of the insulating layer is PET, its typical characteristics are insulation, electrical breakdown resistance, heat resistance, wear resistance and flame retardancy, and its thickness is 125 μm.

The adhesive layer 2 is made of acrylic glue with anti-lifting properties, and its thickness is 50 The glue can also change the thickness or increase the flame resistance as needed.

Typically, the tape of type 2 is as follows: the adhesive layers on both sides of the insulating layer are back-to-back design, and the acrylic foam tape (ACX) with high cohesion is used, the thickness is 1.5 mm, and the number on the two sides is two. Due to the fluctuation of the binding position of the adhesive layer in the production, the adhesive layers on both sides are intentionally set to be of different widths, and the respective widths are 10 mm and 13 mm, respectively. The size and quantity can be changed according to the needs and characteristics of the adhesive layer, and flame retardant acrylic foam tape (ACX) can be used according to requirements. The insulation layer remains the same as type 1.

Acrylic Foam Tape (ACX)

Acrylic Foam Tape (ACX), which consists of a high-performance acrylic adhesive, is coated by an extrusion process, and cross-linked using UV. The material and the manufacturing process endowed acrylic foam tape (ACX) has many advantages: firstly, the adhesive has strong adhesion, and its peeling force on steel plate and PC board can be more than 25 N/cm. The modified acrylic foam tape (ACX) also has good binding properties (greater than 20 N/cm) for low surface energy materials; secondly, the adhesive has very high cohesion (static shearing force is greater than 5000 min), i.e. it has very good shape retention characteristics; thirdly, the adhesive has very good temperature and weather resistance, and after being kept in the temperature range of −40 to 125° C. or in the high humidity environment for 3 months, there is no significant change in performance; fourthly, acrylic foam tape (ACX) has different thicknesses (100 μm-3000 μm) to meet different needs.

In addition to the strong cohesion, the ACX tape used in the invention also has unique viscoelasticity, which not only provides expansion space for the battery, but also effectively reduces vibration of the battery during use, that is, it has damping effect.

It should be understood that in the present invention, the peeling force is tested as follows (J0PMA002):

test sample: acrylic foam tape (ACX), acrylic tape

test plate: ASTM steel sheet, PP sheet, PET sheet, etc.

test width: 20 mm

rolling conditions: 4 kg roller, rolling speed 10 m/min, 5 rolling back and forth

reinforced film: 38 μm PVC

peeling angle: 180′ (<200 μm), 90′ (>200 μm)

peeling speed: 300 mm/min

test environment: 23±1° C., 50±5% RH

test unit: N/cm;

The cohesion is tested as follows (J0PME002):

test sample: acrylic foam tape (ACX), acrylic tape

test plate: ASTM steel plate

test area: 20 mm*13 mm

load: 1 kg

rolling conditions: 2 kg, 300 mm/min, 2 rolling back and forth

test temperature: 40/70° C.

test unit: min;

Tape compression test is performed as follows (J0PMI002):

test sample: acrylic foam tape (ACX), acrylic tape

sample size: 50 mm*50 mm

test speed: 50 mm/min

test unit: M Pa @Compress ratio

test environment: 23±1° C., 50±5% RH;

test results: 0.06˜0.5 MPa@25% , 0.4-3 MPa@50%

T-shaped drawing force (J0PM0146) is tested as follows:

test sample: acrylic foam tape (ACX), acrylic tape

test plate: aluminum

sample size: 25 mm*25 mm

preparation pressure: 110 N, 15 s

infiltration time: 24 h

test speed: 300 mm/min

test environment: 23±1° C., 50±5% RH

test unit: N;

test results: >500 N

Breakdown voltage is tested according to GB/T 1408.1-2006. The test sample is an insulating film or a glued tape. The insulation layer has a compressive strength greater than 4 KV.

Cell

In the present invention, the length of the cell is selected from the group consisting of: 120-200 mm, 140-180 mm, 150-175 mm;

the height of the cell is selected from the group consisting of 70-140 mm, 80-130 mm and 90-120 mm;

the thickness of the cell is selected from the group consisting of 10-50 mm and 15-30 mm.

The cell size tested in the present invention is 170 mm *110 mm*20 mm (L*H*T) (only for illustration, and it is not intended to limit the invention). For battery size, the typical specification is the VDA standard, and the recommended dimensions are as follows. Different manufacturers have their own special sizes.

For different vehicle applications, the VDA defines a total of five square battery sizes:

| Application vehicle | Width(mm) | Thickness(mm) | Height(mm) |
|---|---|---|---|
| HEV | 120 | 12.5 | 85/<89 |
| PHEV/REV | 173 | 21 | 85/<95 |
| PHEV/REV | 148 | 26.5 | 91/<101 |
| EV | 173 | 32 | 115/<125 |
| EV | 173 | 45 | 115/<125 |

Prismatic Battery Module

The design of the prismatic cell (battery) module needs to consider the following factors: 1. expansion of the cell during use; 2, insulation between the cells; 3, cell fixing and anti-vibration; 4, cell size tolerance and shape tolerance; 5, thermal management inside the cell module; 6, production process feasibility and simplicity; 7, economic factors and long-term stability. Currently, batteries have different group designs, but each design has its drawbacks.

At present, the most design is to add a “mouth” shaped plastic or rubber frame between the cells, and the space formed by the frame structure can absorb the expansion of the cell during use. Since the non-adhesive frame cannot fix the adjacent cells, it is necessary to apply a very large pressure to the cells in the direction of stacking the cells, and structural glue needs to be used on the sides of the cells to fix the cells. Very large tensile forces put forward higher demands on the structural parts, and the introduction of structural glue also increases the complexity of the process. In addition, the frame structure only solves the expansion problem of the cell, and it is necessary to apply an insulating film to the cell in advance to solve the insulation problem.

In addition to the design of the “mouth” shaped frame, in order to fix adjacent cells, some manufacturers add double-sided tape having similar areas with adjacent cell areas between adjacent cells. The introduction of double-sided tape can effectively fix the cells and prevent the cells from shaking. However, because the tape does not provide a buffer space for the cell, and its thinner thickness does not compensate for the dimensional tolerance of the cell. Therefore, this group method has strict requirements on the dimensional uniformity of the cells, and does not allow the cells to excessively expand during use.

In this regard, the present invention provides the following improved prismatic battery module:

Solution One:

As shown in FIG. 1, besides the release layer of the tape, the tape has three-layer different structures, namely an adhesive layer 1, an insulating layer and an adhesive layer 2. The adhesive layer 1 is composed of an adhesive with high cohesion to maintain its shape under higher temperature and pressure; the insulating layer can be composed of plastic films, such as PET, PC, PP, PI, PES etc., and it has good heat resistance, insulation, flame resistance and tensile resistance, wear resistance etc.; the adhesive layer 2 is composed of adhesives with good adhesive properties and anti-shedding properties.

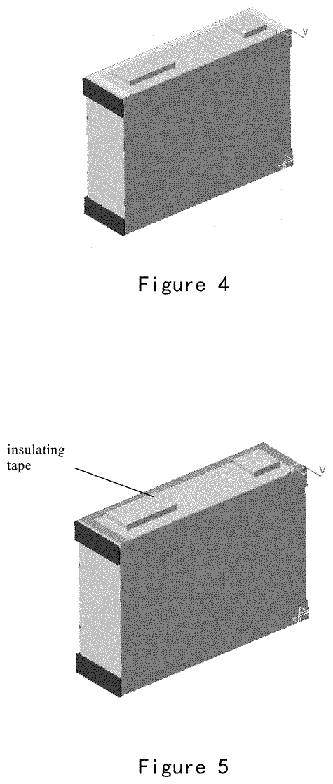

As shown in FIG. 4, the adhesive layer 2 is directly bound to the surface of the cell. During use, part of the tape at the top and bottom can be cut according to actual needs, so that the tape is bent and bound to the top and bottom of the cell. When the module is assembled, the adhesive layer 1 will be directly bound to the adjacent cell and the side plate. The binding between the cells, between the cell and the side plate, and between the cell and the end plate can effectively prevent the vibration of the cell. During the design for the module, the width and thickness of the adhesive layer 1 can be adjusted to bring the following advantages: 1. compensating for the dimensional tolerance of the cell, which is more conducive to the matching between the cells; 2. forming gaps between the cells at the position where the adhesive tape is not attached so as to absorb the expansion of the cell during use; 3. the gap between the cells has a very low thermal conductivity, which effectively suppresses the transfer of heat to the adjacent cell by the overheated cell; 4. the tape on the side of the cell can be directly bound to the side plate, which is more effective in avoiding the shaking of the cell; 5. compared with the structural glue binding, the design will not cause binding failure caused by violent vibration; 6. air can flow in the gap between the cells, which can speed up heat exchange between the inside and outside of the module to prevent heat from accumulating inside the module. In addition, the binding method of the tape facilitates the automatic operation of the device and greatly improves the production efficiency.

It should be understood that in practical applications, the tape may be located only on one main surface of the cell, or may be located on one main surface and two adjacent sides of the cell, and a three-side binding is preferred. The tape may also be bound to a partial area of the top and bottom surfaces of the cell.

Solution Two:

As shown in FIG. 2 or FIG. 3, the tape also has a three-layer structure. Different from solution one, two sides of the tape are both composed of adhesive with high cohesion. The design can increase the gap between the cells and reduce the deformation of the adhesive layer during compression. The insulation layer can be composed of plastic films such as PET, PC, PP, PI, and PES, which has good heat resistance, insulation, flame resistance and tensile resistance and wear resistance.

During use, in order to avoid direct contact between the corners of the cells and direct contact between the corner of the cell and other conductive media, it is necessary to bind insulating tape onto partial areas of the top surface, the bottom surface and the corners of the cell in advance (as shown in FIG. 5). The tape can be directly adhered to the surface of the cell. Unlike solution one, this solution does not require die cutting and contributes to automated production. During the design for the module, the width and thickness of the adhesive layer 1 can be adjusted to bring the following advantages: 1. compensating for the dimensional tolerance of the cell, which is more conducive to the matching between the cells; 2. forming gaps between the cells at the position where the adhesive tape is not attached so as to absorb the expansion of the cell during use; 3. the gap between the cells has a lower thermal conductivity, which effectively suppresses the transfer of heat to the adjacent cell by the overheated cell; 4. the tape on the side of the cell can be directly bound to the side plate, which is more effective in avoiding the shaking of the cell; 5. the insulating layer is not in direct contact with the cell, and the shrinkage of the insulating film caused by overheating of the cell can be avoided; 6. the air can flow in the gap between the cells to accelerate the heat exchange between the battery and the outside; 7. compared with the structural glue binding, the solution does not cause binding failure caused by violent vibration. In addition, the binding method of the tape facilitates the automatic operation of the device and greatly improves the production efficiency.

It should be understood that the prismatic battery module of the present invention can be applied not only to electric vehicles, but also to electric devices including (but not limited to): electric bicycles, electric forklifts, and electric tools.

It should be understood that, compared with the existing battery module in which the tape is only applied on single side of the cell, the battery module wherein the three-side tape is used can achieve better binding performance, and the integrated binding can simplify the process.

Compared with the prior art, the invention has the following main advantages:

(1) viscoelastic acrylic foam tape (ACX) has very high binding performance, and it can absorb pressure and provide tensile force during vibration, and it has excellent damping effect, which can greatly weaken the module vibration to avoid fatigue damage of the components;

(2) the space formed by the strip-shaped acrylic foamed tape (ACX) and the compressibility of the tape can absorb the expansion of the cell during use;

(3) the air has a very low thermal conductivity, and the gap between the cells can isolate the heat transfer between adjacent cells. When a cell appears thermal runaway, it can delay the influence on adjacent cells.

(4) in this design, the insulating film covers only three sides of the cell, and one main surface is bare, and the strip-shaped structure allows the space between the cells to communicate with the external space. If active air cooling is used, convection will be formed between the external air and the air among the cells. The heat inside the module can be quickly taken out by the flowing air, which avoids the accumulation of heat inside the module and reduces the temperature difference between different positions of the module. In addition, the space is convenient for the implantation of temperature sensor which can more accurately collect the internal temperature of the module;

(5) after the cells are stacked, the side tapes can be attached and fixed to the side plates, which can omit the use of structural glues and greatly simplify the process;

(6) acrylic foamed tape (ACX) has a long-lasting viscoelasticity, and in the case of severe vibration, even if a binding defect occurs, it can be bound again after that, that is, it has a self-healing effect.

The present invention will be further illustrated below with reference to the specific examples. It should be understood that these examples are only to illustrate the invention but not to limit the scope of the invention. The experimental methods with no specific conditions described in the following examples are generally performed under the conventional conditions, or according to the manufacturer's instructions. Unless indicated otherwise, parts and percentage are calculated by weight.

Unless otherwise defined, all professional and scientific terminology used in the text have the same meanings as known to the skilled in the art. In addition, any methods and materials similar or equivalent to those described can be applied to the methods of the present invention. The method of the preferred embodiment described herein and the material are only for demonstration purposes.

### Example 1

### Type One Tape

As shown in FIG. 1, the tape comprises: an adhesive layer 1, an insulating layer and an adhesive layer 2, wherein

the adhesive layer 1 comprises two strip-shaped adhesive layers respectively bound to the upper and lower ends of one side of the insulating layer, and are symmetrically disposed, and both the strip-shaped adhesive layers are acrylic foamed tapes (ACX) having a width of 10 mm and a thickness of 1.5 mm;

the insulating layer is a PET material having a width of 120 mm and a thickness of 80 μm;

the adhesive layer 2 is an acrylic glue layer having the same area as the insulating layer, having a width of 120 mm and a thickness of 30 μm;

the farthest distance of the two strip-shaped adhesive layers is 110 mm (i.e., the distance between the upper side of the strip-shaped adhesive layer at the upper end and the lower side of the strip-shaped adhesive layer at the lower end).

### Example 2

### Type 2 Tape

As shown in FIG. 2, the tape comprises: an adhesive layer 1, an insulating layer and an adhesive layer 2, wherein

the adhesive layer 1 comprises two strip-shaped adhesive layers respectively bound to the upper and lower ends of one side of the insulating layer, and are symmetrically disposed, and both the strip-shaped adhesive layers are acrylic foamed tapes (ACX) having a width of 10 mm and a thickness of 1.0 mm;

the insulating layer is a PET material having a width of 120 mm and a thickness of 100 μm;

the adhesive layer 2 comprises two strip-shaped adhesive layers respectively bound to the upper and lower ends of another side of the insulating layer, and are symmetrically disposed, and both the strip-shaped adhesive layers are acrylic foamed tapes (ACX) having a width of 13 mm and a thickness of 1.0 mm;

both the farthest distance of the two strip-shaped adhesive layers in the adhesive layer 1 and in the adhesive layer 2 are 110 mm (i.e. the distance between the upper side of the strip-shaped adhesive layer at the upper end and the lower side of the strip-shaped adhesive layer at the lower end).

### Example 3

### Type 2 Tape

As shown in FIG. 3, the tape comprises: an adhesive layer 1, an insulating layer and an adhesive layer 2, wherein

the adhesive layer 1 comprises two strip-shaped adhesive layers respectively bound to the upper and lower ends of one side of the insulating layer, and are symmetrically disposed, and both the strip-shaped adhesive layers are acrylic foamed tapes (ACX) having a width of 10 mm and a thickness of 1.5 mm;

the insulating layer is a PET material having a width of 120 mm and a thickness of 125 μm;

the adhesive layer 2 comprises two strip-shaped adhesive layers respectively bound to the upper and lower ends of another side of the insulating layer, and are symmetrically disposed, and both the strip-shaped adhesive layers are acrylic foamed tapes (ACX) having a width of 13 mm and a thickness of 1.5 mm;

the farthest distance of the two strip-shaped adhesive layers in the adhesive layer 1 is 110 mm (i.e. the distance between the upper side of the strip-shaped adhesive layer at the upper end and the lower side of the strip-shaped adhesive layer at the lower end).

the farthest distance of the two strip-shaped adhesive layers in the adhesive layer 2 is 113 mm.

It should be understood that in Examples 1-3, the acrylic foamed tape (ACX) is specifically acrylic foam glue as defined herein.

### Example 4

### Prismatic Battery Module (Solution 1)

As shown in FIG. 4, the tape in example 1 is used, and a square cell having the following size is used: a length of 170 mm, a height of 110 mm, and a thickness of 20 mm, and the adhesive layer 2 is directly bound to one main surface and two adjacent sides of the cell. After proper cutting, the upper and lower edges of the tape are bound to a partial area of the top and bottom surfaces of the cell. The foregoing operation was repeated to obtain a plurality of cells bound with a tape.

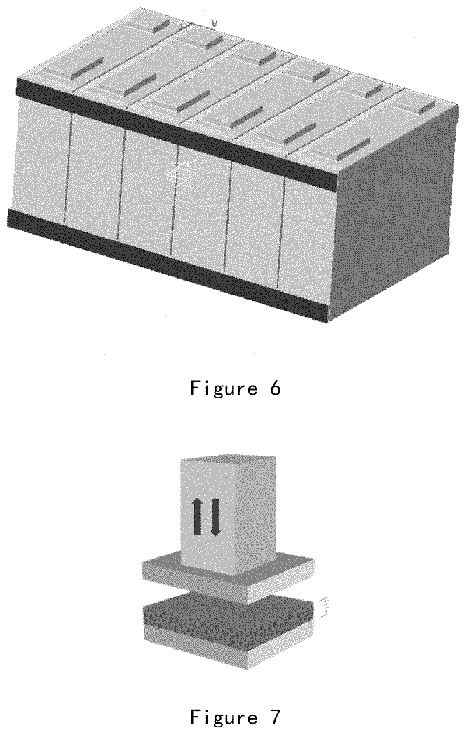

Then, as shown in FIG. 6, the plurality of cells bound with a tape are directly bound through the adhesive layer 1 bound on the main surface, and then the tape is bound on a main surface of the outermost layer without tape, and then bound with the end plates at both ends. The stacked cells are compressed in the stacking direction, and the side plates are bound with the tape on the side of the cell for preliminary fixing. Finally, the side plate and the end plate are welded to obtain the prismatic battery module.

### Example 5

### Prismatic Battery Module (Solution 2)

As shown in FIG. 5, the tape in example 3 is used, and a square cell having the following size is used: a length of 170 mm, a height of 110 mm, and a thickness of 20 mm, and a single-side insulating tape (its materials can be insulating materials such as PET, PI, PP) is bound to the top surface and the bottom surface and adjacent corners of the cell, and then the adhesive layer 2 is directly bound to one main surface and two adjacent sides of the cell, and repeat the foregoing operation to obtain a plurality of cells bound with a tape.

Then, as shown in FIG. 6, the plurality of cells bound with a tape are directly bound through the adhesive layer 1 bound on the main surface, and then the tape is bound on a main surface of the outermost layer without tape, and then bound with the end plates at both ends. The stacked cells are compressed in the stacking direction, and the side plates are bound with the tape on the side of the cell for preliminary fixing. Finally, the side plate and the end plate are welded to obtain the prismatic battery module.

### Comparative Example 1

### Prismatic Battery Module C1

The same as example 4, the difference is that the cells are insulated and bound by ordinary tape (such as PET double-sided tape or non-woven double-sided tape), and are bound to the side structural parts by using structural glue.

ACX in example 4 can be compressed (the compression ratio is greater than 20%) so as to compensate the dimensional tolerance of the cell; the gap formed by the aseismatic damping glue provides space for expansion of the cell; example 4 completes insulation, binding, binding with structural parts between the cells in one step, and there is no need to apply structural glue, thus simplifying the production process and saving production time.

The above-mentioned ordinary tape has a thin thickness and cannot compensate for the dimensional difference of the battery. Therefore, the size of the cell is required to be highly uniform; in this grouping mode, the cells are densely stacked, which causes the heat accumulation in the module, and the life of the battery will be affected; as to the battery module bound by ordinary tape, during use, the life of the module will be reduced since the expansion of the cell will extrude the structural parts resulting in the occurrence of breakage in structural parts and solder joint. There is no need to apply structural glue in example 4, so the production process can be simplified and production time can be saved.

### Comparative Example 2

### Prismatic Battery Module C2

The same as example 5, the difference is that the expansion space of the cell is provided by introducing a “mouth” frame between the cells, and the cell is bound to the side structure part by using the structural glue.

Both example 5 and the prismatic battery module C2 can introduce the expansion space for battery expansion. However, the “mouth” frame in the prismatic battery module C2 cannot provide insulation between the cells, so it is necessary to bond the insulating tape on the surface of the cell in advance; the “mouth” frame does not have viscoelasticity, so it cannot form a damping effect so as to weaken the negative effect caused by the vibration; the “mouth” frame cannot provide the adhesion between the adjacent cells, in order to ensure the effective fixation of the cells, it is necessary to apply a very large force to the cells, and excessive pressure often leads to the deformation of the cells and the generation of defects. However, in example 5, since the tape has a fixed function, the pressure between the cells can be greatly reduced (the force value depends on the compression ratio and the binding area of the tape); the double-sided adhesive bound on both sides of the “mouth” frame can provide adhesion between the cells, but the process of the component is cumbersome, and a large amount of material is wasted during the die-cutting process; there is no need to apply the structural glue in example 5, which simplifies the production process and saves production time.

Comparison Test for Tape Performance

The following compression tests were performed on acrylic foam tape (ACX), PE foam glue, PU foam glue, ACX+PE tape and ACX+PU tape:

test equipment: Zwick universal material testing machine

sample area: 50 mm*50 mm

sample compression judgment force value: 1 KPa

compression speed: 50 mm/min, 600 mm/min

maximum compression: 50%

rest time after compression and rebound: lOs

test unit: KPa

See FIG. 7 for sample mounting. The test sample is placed horizontally on the lower plate.

In which, the acrylic foam tape (ACX) has a test thickness of 10 mm and is obtained by stacking 10 single acrylic foam tapes having a single layer thickness of 1 mm;

PE foam glue refers to a double-side glue formed by coating acrylic glue on both sides of PE foamed substrate (the thickness of the PE foam glue is about 1.5 mm+0.1 mm), wherein the substrate has a thickness of 1.5 mm, and the amount of glue coated on a single surface of the substrate is 50 g/m²; at the testing time, 7 above PE foam glue were laminated and tested;

PU foam glue refers to a double-side glue formed by coating acrylic glue on both sides of PU foamed substrate (the thickness of the PU foam glue is about 1.5 mm+0.1 mm), and the substrate has a thickness of 1.5 mm, and the amount of glue coated on a single surface of the substrate is 50 g/m2; at the testing time, 7 above PU foam glue are laminated and tested;

ACX+PE tape refers to a composite tape of acrylic foamed tape and PE foam glue. The acrylic foamed tape has a thickness of 1.0 mm, and PE foam glue has a thickness of 1.5 mm; when tested, 4 above ACX+PE tapes were laminated and tested;

ACX+PU tape refers to a composite tape of acrylic foamed tape and PU foam glue. The acrylic foamed tape has a thickness of 1.0 mm, and the PU foam glue has a thickness of 1.5 mm. When tested, 4 above ACX+PU tapes were laminated and tested.

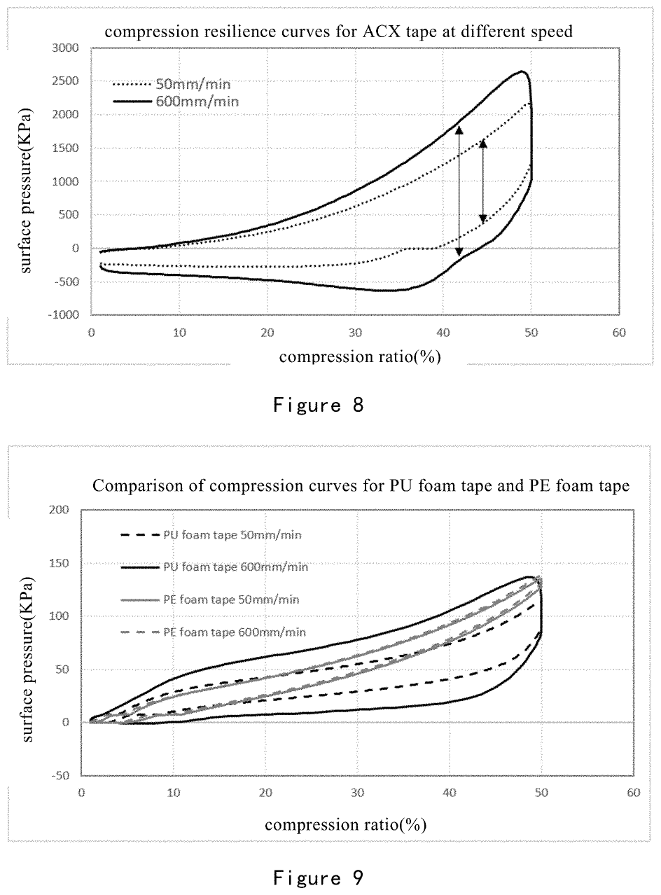

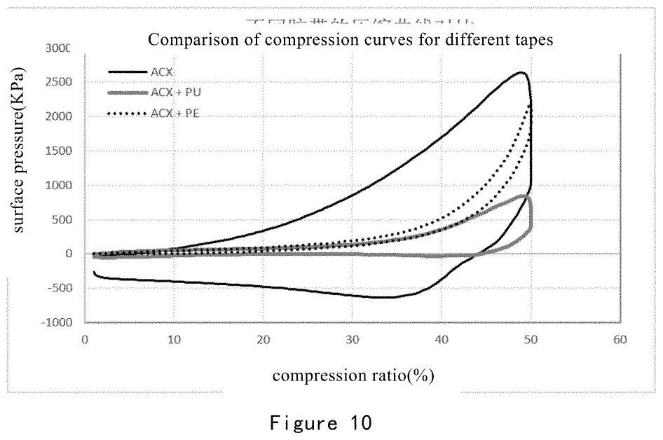

The compression resilience curve for acrylic foam tape is shown in FIG. 8. The compression resilience curves for PE foam glue and PU foam glue are shown in FIG. 9. The compression resilience curve for ACX+PE tape and ACX+PU tape are shown in FIG. 10.

FIG. 8 shows the surface pressure curve for ACX tape at different compression and resilience. It can be seen from FIG. 8 that: 1. the compressive force of the tape increases sharply with the increase of the compression ratio. In actual use, it can provide sufficient supporting force for adjacent cells to avoid relative shaking of the cells in small vibrations. 2, at the same compression rate, the compression force value and the resilience force value are different (as indicated by the arrow in the figure), the difference can weaken the shaking between the cells, and as the speed increases, the difference between compression and resilience is increased, which indicates that the damping effect of the tape increases as the vibration increases.

FIG. 9 shows the compression resilience curves for PU foam tape and PE foam tape. From FIG. 9, it can be seen that when the foam compression ratio is 50%, its surface pressure value is less than 150 KPa, and the differences between compression values and resilience values are small. The material has the following problems in use: 1. the material is too soft to provide sufficient supporting force for adjacent cells; 2. the difference between compression values and resilience values is small, and it is difficult to provide sufficient damping.

FIG. 10 is the compression resilience curves for ACX, ACX+PU tape and ACX+PE tape. Because PE foam and PU foam are soft and have no viscoelasticity, its compression force and the difference between compression force and resilience force are small, and its damping effect is not as good as ACX alone.

All literatures mentioned in the present invention are incorporated by reference herein, as though individually incorporated by reference. Additionally, it should be understood that after reading the above teaching, many variations and modifications may be made by the skilled in the art, and these equivalents also fall within the scope as defined by the appended claims.

1. A prismatic battery module comprising:
a plurality of cells;
one or more structural parts; and
one or more adhesive tapes,
wherein
cells of the plurality of cells are arranged side by side,
an adhesive tape, on each cell of the plurality of cells, is continuously bound onto one main surface and two adjacent side surfaces of the cell,
the adhesive tape is bound to another one main surface of a cell that is located at the end of the plurality of cells arranged side by side, such that the adhesive tape is bound onto all around the plurality of cells arranged side by side,
the plurality of cells is bound with each other by the adhesive tape respectively bound onto one main surface of each of the cells,
the structural part is configured to fix the plurality of cells,
the structural part includes two side plates respectively disposed on two side surfaces of the plurality of cells arranged side by side and two end plates respectively disposed on two main surfaces of the plurality of cells arranged side by side, and
the two side plates and the two end plates are bound to the plurality of cells by adhesive tapes bound to all around the plurality of cells arranged side by side.

2. The prismatic battery module according to claim 1, wherein the adhesive tape comprises an adhesive layer, an insulating layer, and an adhesive layer;
the adhesive layer includes a first adhesive layer bound to the upper end of the first main side of the insulating layer and a second adhesive layer bound to the lower end of the first main side of the insulating layer;
the adhesive layer is bound to the second main side of the insulating layer, and
the adhesive layer is an aseismatic damping glue selected from the group consisting of:
a1) acrylic foam glue;
a2) acrylic foam glue coated with first glue on one side; and
a3) acrylic foam glue coated with first glue on both sides.

3. The prismatic battery module according to claim 2, having one or more features selected from the group consisting of:
1) the insulating layer is formed of at least one material selected from the group consisting of: PET, PE, PP, PC, PI, PBT, PES, and a combination thereof;
2) the adhesive layer 2-is selected from the group consisting of acrylic tape, rubber tape, silicone tape and aseismatic damping glue, wherein, when present, the aseismatic damping glue is selected from the group consisting of:
a1) acrylic foam glue;
a2) acrylic foam glue coated with first glue on one side; and
a3) acrylic foam glue coated with first glue on both sides.

4. The prismatic battery module according to claim 2, having one or more features selected from the group consisting of:
1) a width of the first adhesive layer and a width of the second adhesive layer are same or different, and are independently selected from the group consisting of: 5-20 mm, 8-18 mm, or 10-15 mm;
2) the first adhesive layer and the second adhesive layer have a same thickness which is selected from the group consisting of 0.5-5 mm, 0.8-3 mm, or 1-2 mm;
3) the insulating layer has a thickness selected from the group consisting of: 10-300 μm, 25-250 μm, 40-150 μm, or 50-130 μm;
4) the insulating layer has a width selected from the group consisting of: 50-200 mm, 70-150 mm, or 80-140 mm;
5) the adhesive layer 2-has a thickness selected from the group consisting of 10-100 μm, 25-80 μm, 30-60 μm, 0.1-2.5 mm, 0.3-2.2 mm, 0.5-2 mm, 0.8-1.8 mm, or 1-1.8 mm;
6) a width of the adhesive layer 2-is the same as the width of the insulating layer.

5. The prismatic battery module according to claim 2, wherein the adhesive layer comprises a third adhesive layer bound to an upper end of the second main side of the insulating layer and a fourth adhesive layer bound to lower end of the second main side of the insulating layer.

6. The prismatic battery module according to claim 5, having one or more features selected from the group consisting of:
1) the third adhesive layer and the fourth adhesive layer may have a same or different widths which are independently selected from the group consisting of: 5-20 mm, 8-18 mm, or 10-15 mm;
2) the third adhesive layer and the fourth adhesive layer have a same thickness which is selected from the group consisting of 0.5-5 mm, 0.8-3 mm, and 1-2 mm.

7. The prismatic battery module according to claim 5, wherein at least one selected from
a ratio of the width of the third adhesive layer to the width of the first adhesive layer is 1-1.5, and the first adhesive layer is symmetrically disposed with the third adhesive layer, and
a ratio of the width of the fourth adhesive layer to the width of the second adhesive layer is 1-1.5, and the second adhesive layer is symmetrically disposed with the fourth adhesive layer.

8. The prismatic battery module according to claim 2, wherein the adhesive layer is aseismatic damping glue selected from the group consisting of:
a1) acrylic foam glue;
a2) acrylic foam glue coated with first glue on one side; and
a3) acrylic foam glue coated with first glue on both sides.

9. The prismatic battery module according to claim 2,
wherein
a single cell has a thickness of D1,
the adhesive layer 1 has a thickness of D2, and
D1/D2 is 2.5 to 30.

10. The prismatic battery module according to claim 2, wherein the margin of the insulating layer of the adhesive tape in a width direction is coated onto a partial region of a top surface and a bottom surface of each of the cells.
